(19) United States
(12) Patent Application Publication
(10) Pub. No.: US 2004/0064788 A1
(43) Pub. Date: Apr. 1, 2004

(54) System and method for generating source code for an XML application

(75) Inventors: Srilekha Krishnan Gownder, Austin, TX (US); Kumar Marappan, Round Rock, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 10/262,501

(22) Filed: Sep. 30, 2002

(51) Int. Cl. G06F 9/45

(52) U.S. Cl. 715/513

(57) ABSTRACT

A system and method for generating source code that creates an XML document is presented. Processing identifies tags within an HTML file and generates a hierarchical file that includes an element for each tag using a Jtree Java class. A developer enters general attribute values and validation attribute values corresponding to each element. A code generator generates a source code file that includes code for each element. The source code file is input into a Java Virtual Machine (JVM). The JVM receives data values from the HTML file, validates the data values, and generates the XML document.

### BACKGROUND OF THE INVENTION

1. Technical Field

The present invention relates in general to a system and method for generating source code for an XML application. More particularly, the present invention relates to a system and method for extracting HTML fields and using the HTML fields to generate source code that generates XML documents based upon the corresponding HTML field inputs.

2. Description of the Related Art

Web-based information exchange and management using a global computer network, such as the Internet, continues to evolve. Web-based software projects typically have two development efforts, which are a presentation layer effort and a business logic layer effort. The presentation layer effort includes web page design and development which is typically performed by a web page designer. The business logic layer effort includes program development and database development that a computer programmer typically supports.

Hyper Text Mark-up Language (HTML) has been a primary language to develop the presentation layer because it enables the creation of web pages that may be viewed on most browsers. A challenge found with HTML is that HTML does not give a computer system an ability to discern data. To a computer system, HTML is a series of characters and numbers. Therefore, HTML has typically not been used in business logic layer development.

Extensible Markup Language (XML) is becoming a standard in managing data at the business logic layer. XML is also being used at the presentation layer to create web pages. The difference between XML and HTML is that XML adds tags to data so that XML may be processed by most applications. A computer system is able to understand characters and numbers within an XML document by using the tags associated with the characters and numbers in the XML document. For example, an application is able to understand that the XML line “<name> John Doe </name>” includes a “name” and that the name is “John Doe”.

In most instances, a web-based software system exchanges data between the presentation layer and the business logic layer. For example, an e-commerce site may have a user enter information at the presentation layer, such as an account number, and the web-based software system passes the information to the business logic layer for processing. Software code is required to obtain the information from the presentation layer (i.e. HTML) and generate XML documents for processing at the business logic layer. A challenge found with writing the software code is that a computer program developer usually writes the code which takes time away from him developing the business logic, which is a poor use of resources in a software project.

Another challenge found is that typographical mistakes occur when a computer program developer writes the interface software code. For example, if a field in an HTML file is “blue”, and the computer program developer writes code to interface to a field named “bluee”, the interface software will not function properly.

What is needed, therefore, is way to automatically generate interface code using HTML field names in an HTML page.

### SUMMARY

It has been discovered that the aforementioned challenges are resolved by amending a parsed HTML file and generating source code using the amended file. Processing receives the parsed file and generates a hierarchical file using a Jtree Java class. A developer amends general attribute values and validation attribute values to the hierarchical file and generates source code using the amended file. The source code may be used in conjunction with HTML data values to generate an XML document.

The HTML file is input to a parser which searches for HTML tags within the HTML file. When the parser detects an HTML tag, the parser invokes a parser callback command to analyze the detected HTML tag. The parser callback command is configured to analyze HTML tags and store relevant tags corresponding to generating source code. For example, the parser callback command may be configured to store relevant HTML tags such as “hidden”, “input”, “textarea”, “select”, “checkbox”, and “radio”. If the parser sends a relevant tag to the parser callback command, the parser callback command stores information corresponding to the relevant tag (i.e. name and size) in a hash table. On the other hand, if the parser sends an HTML tag to the parser callback command that is not relevant, the parser callback command ignores the tag. The parser continues to search the HTML file for HTML tags until each HTML tag is detected.

Once the parser stores information for each relevant HTML tag in the hash table, processing invokes the Jtree command. Jtree is a Java class that creates a hierarchical file using tag information stored in the hash table. The hierarchical file includes an element corresponding to each relevant HTML tag.

The developer amends general attribute and validation attribute information in the hierarchical file. General attributes are attributes that are used to generate the source code. For example, a general attribute may be “size” which represents the number of digits required for a valid customer account number and the general attribute “size” may have a corresponding attribute value of “10”. Validation attributes are attributes that are used to generate a validation routine which validates data values received from an HTML file. Validation attribute values include a name of a Java class that either 1) generates code to perform the validation or 2) the name of the class that shall perform the validation itself.

When the developer is finished amending the hierarchical file, processing generates source code using the amended file. The source code, along with HTML data values, may be input to a Java Virtual Machine (JVM) to generate an XML document for use in a computer systems business logic layer.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a high-level diagram showing a code generator receiving a hierarchical file and generating source wherein the source code is used to generate an Extensible Markup Language (XML) document;

FIG. 2 is a diagram showing processing generating a hierarchical file using JTree and a code generator generating source using the hierarchical file;

FIG. 3A is a developer interface window showing attributes corresponding to a root element of a hierarchical file;

FIG. 3B is a developer interface window showing attributes corresponding to a particular element;

FIG. 4A is a developer interface window showing menu items to create additional elements and attributes for a particular hierarchical file;

FIG. 5 is a high-level flowchart showing steps taken in retrieving an HTML file and generating source code that creates an XML document;

FIG. 6 is a flowchart showing steps taken in generating a hierarchical file;

FIG. 7 is a flowchart showing steps taken in amending a hierarchical file;

FIG. 8 is a flowchart showing steps taken in modifying elements corresponding to a hierarchical file; and

FIG. 9 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

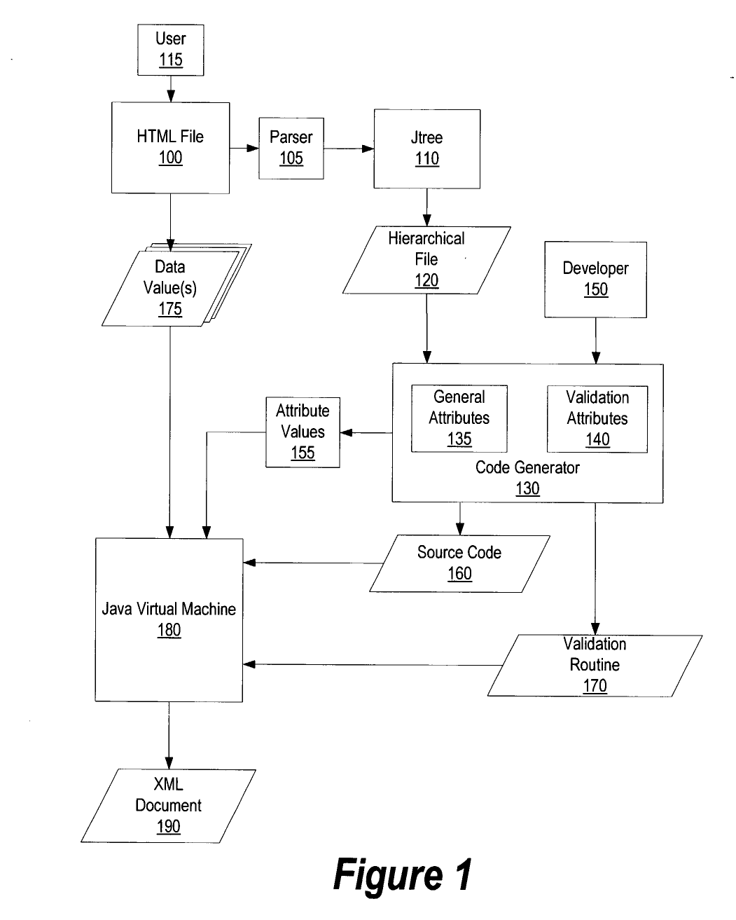

FIG. 1 is a high-level diagram showing a code generator receiving a hierarchical file and generating source code using elements within the hierarchical file. Hyper-Text Markup Language (HTML) file 100 is a file that a computer system uses at a presentation layer. User 115 is able to input information into HTML file 100 and HTML 100 sends the information (data value(s) 175) to the computer system's business logic layer for processing. For example, HTML file 100 may be an e-commerce web page that receives user account information, such as an account number, and sends the account number to a server for processing.

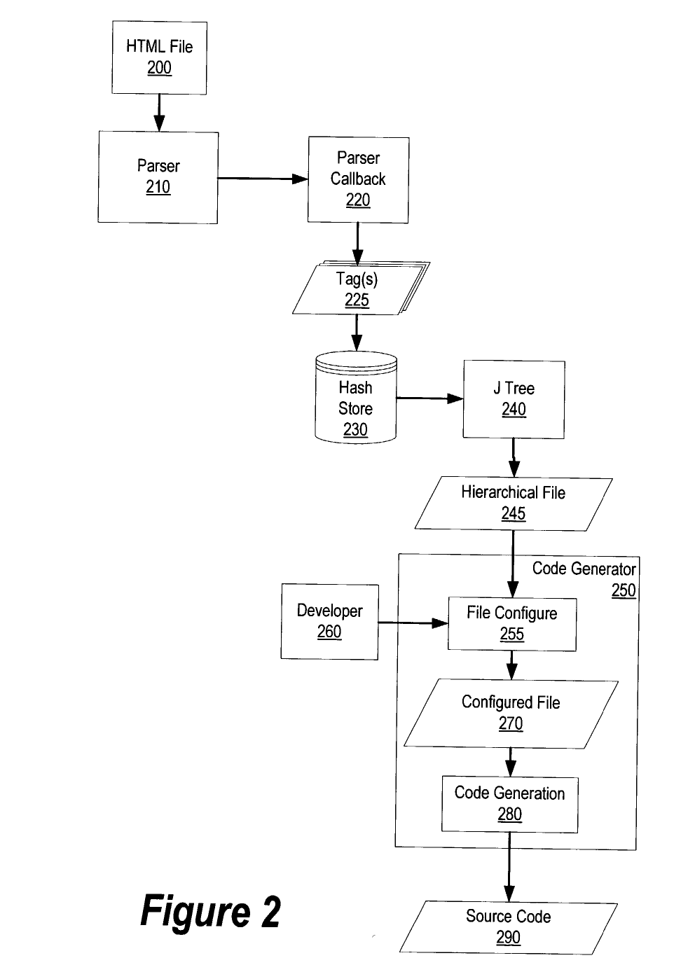

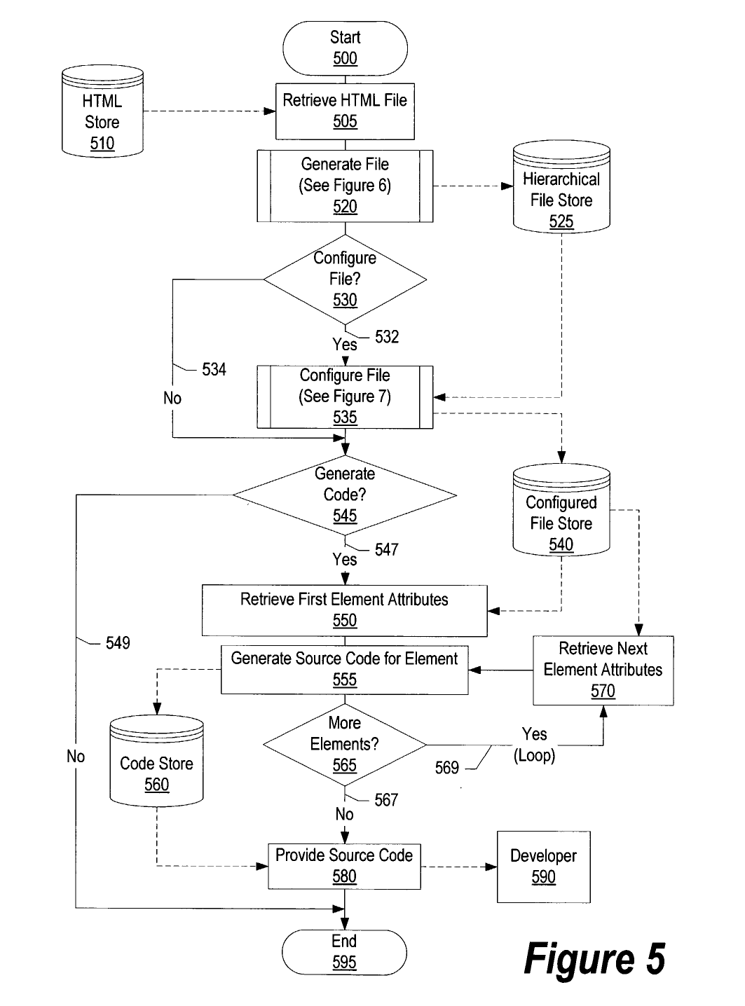

Jtree 110 receives a hash table from parser 105 that includes tags that parser 105 extracted from HTML file 100 (see FIGS. 2, 5, and corresponding text for further details regarding HTML file parsing). Jtree 110 uses the hash table to create hierarchical file 120. Hierarchical file 120 is a file that includes elements corresponding to the HTML tags that are organized hierarchically. Using the example described above, hierarchical file 120 may include an element named “accountnumber”.

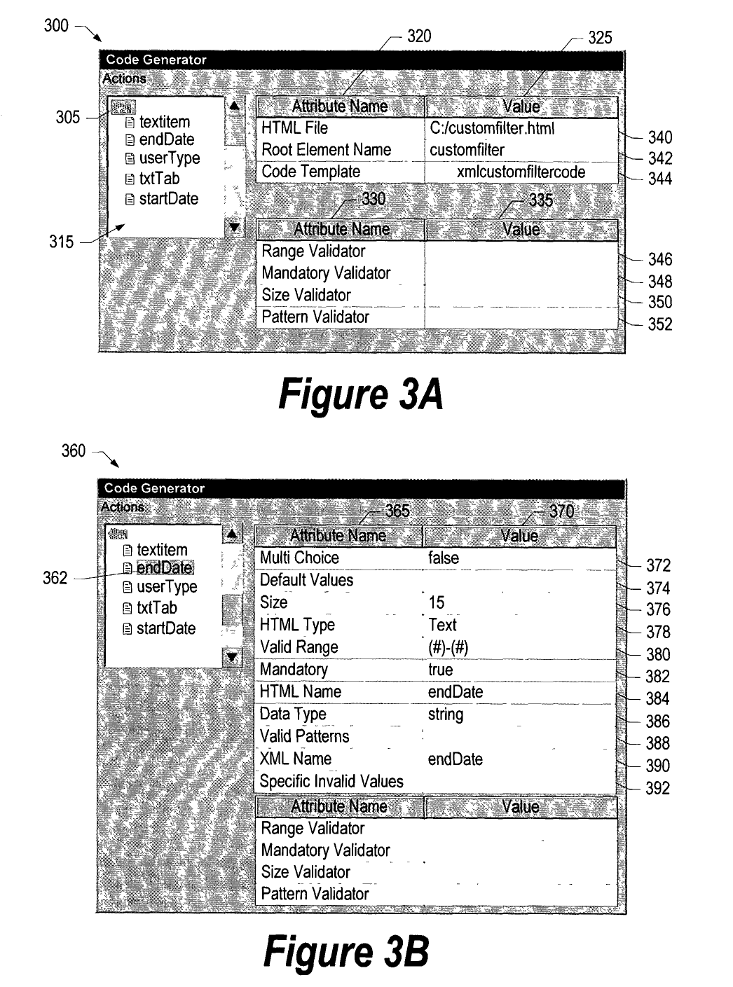

Code generator 130 receives hierarchical file 120 and receives attribute information from developer 150 corresponding to one or more of the elements, such as values associated with general attributes 135 and validation attributes 140. Developer 150 is a user that develops source code, such as a computer program developer. General attributes 135 are attributes that are used to generate source code 160. Using the example described above, a general attribute may be “size” which represents the number of digits required for a valid account number and the general attribute “size” may have a corresponding attribute value of “10” (see FIG. 3B and corresponding text for further details regarding general attribute descriptions). Validation attributes 140 are attributes that are used to generate validation routine 170 which are used to validate data value(s) 175. Validation attribute values are names of Java classes that either 1) generate code to perform a validation or 2) a name of the class that shall perform the validation itself (see FIG. 3A and corresponding text for further details).

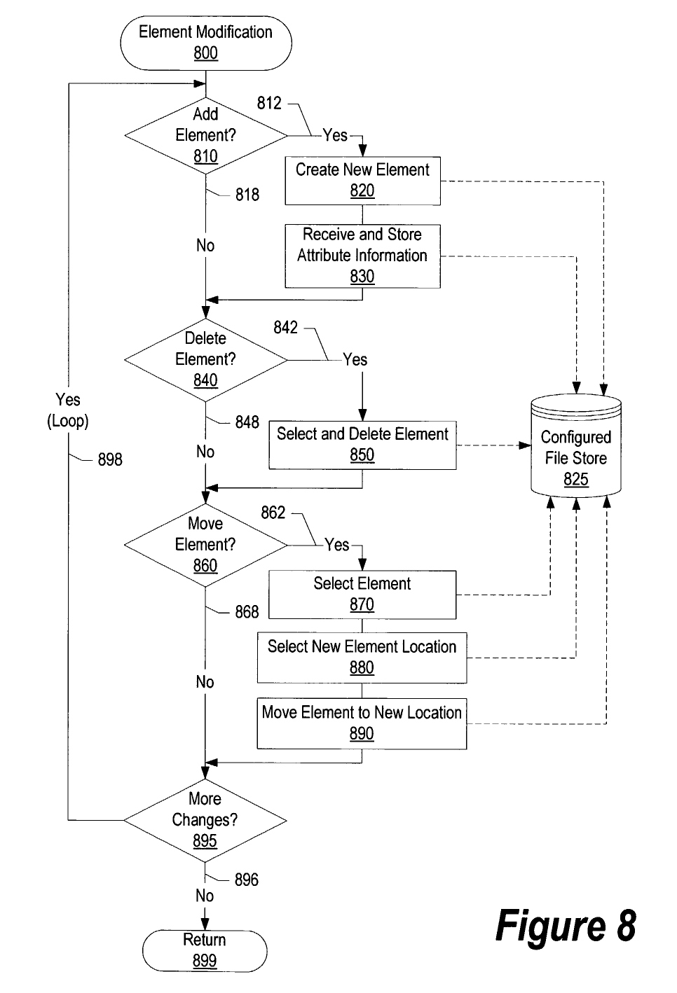

Developer 150 is also able to add and/or move elements. For example, developer 150 may wish to add an element to retrieve a time corresponding to when a customer logged on to HTML file 100. In another example, HTML file 100 may have multiple tags that correspond to identification numbers. In this example, developer 150 may wish to add an “identification” element and nest (i.e. more) each associated identification element under the parent “identification” element (see FIG. 8 and corresponding text for further details regarding element modifications).

Code generator 130 uses hierarchical file 120 with general attributes 135 to generate source code 160 which includes code for each element. Code generator 130 uses validation attributes 140 to generate validation routine 170. Both source code 160 and validation routine 170 are input into Java virtual machine 180 for processing. Java virtual machine 180 receives data value(s) 175 from HTML file 100 and uses source code 160 to generate XML document 190. Java Virtual Machine 180 retrieves attribute values 155 from code generator 130 which include attribute values corresponding to general attributes 135 and validation attributes 140. Java virtual machine 180 uses attribute values 155 and validation routine 170 to ensure that data value(s) 175 abide by specified parameters. Using the example described above, data value(s) 175 may be an account number in which data value(s) 175 should be ten digits long. If data value(s) 175 is more or less than ten digits long, Java virtual machine 180 generates an error. If each value associated with each attribute passes validation checks, Java virtual machine 180 generates XML document 190. XML document 190 incorporates data value(s) 175 and may be used in the computer system's business logic layer for data analysis.

FIG. 2 is a diagram showing processing generating a hierarchical file using Jtree and a code generator generating source using the hierarchical file. Jtree is a Java routine that receives a hash table and generates a hierarchical file based on values within the hash table. HTML file 200 is a file that includes HTML code for a particular screen display. For example, HTML file 200 may include code that generates a registration screen. Parser 210 receives HTML file 200 and searches for HTML tags within HTML file 200. When parser 210 detects an HTML tag, parser 210 invokes parser callback 220 to analyze the detected HTML tag. Using the example described above, parser 210 may detect a “textarea” HTML tag and invoke parser callback 220.

Parser callback 220 is configured to analyze HTML tags and store tags that relate to data entry. For example, parser callback 220 may be configured to store relevant HTML tags such as “hidden”, “input”, “textarea”, “select”, “checkbox”, and “radio”. If parser 210 sends a relevant tag to parser callback 220, parser callback 220 extracts information from the HTML tag and stores the information (i.e. name and size) in hash store 230. Hash store 230 may be stored on a non-volatile storage area, such as a computer hard drive. On the other hand, if parser 210 sends an HTML tag to parser callback 220 that is not relevant, parser callback 220 ignores the tag. Parser 210 continues to search HTML file 200 for HTML tags until each HTML tag is detected.

Once parser callback 220 stores information for each HTML tag in hash store 230, processing invokes Jtree 240. Jtree 240 is a Java class that creates a hierarchical file using tag information stored in hash store 230. Jtree 240 retrieves tag information from hash store 230 and creates hierarchical file 245. which includes an element corresponding to each relevant tag.

Developer 260 configures hierarchical file 245 using file configure 255. File configure 255 may be a subroutine within code generator 250 that provides developer interface windows to developer 260 for adding attribute values and elements see FIGS. 3A, 3B, and corresponding text for further details regarding developer interface windows). Developer 260 may amend general attribute and validation attribute information for each element. General attributes are attributes that are used to generate source code 290. For example, a general attribute may be “size” which represents the number of digits required for a valid customer account number and the general attribute “size” may have a corresponding attribute value of “10” (see FIG. 3B and corresponding text for further details regarding general attribute description). Validation attributes are attributes that are used to generate a validation routine which validates data values received from an HTML file. Validation attribute values include a name of a Java class that either 1) generates code to perform the validation or 2) the name of the class that shall perform the validation itself (see FIG. 3A and corresponding text for further details).

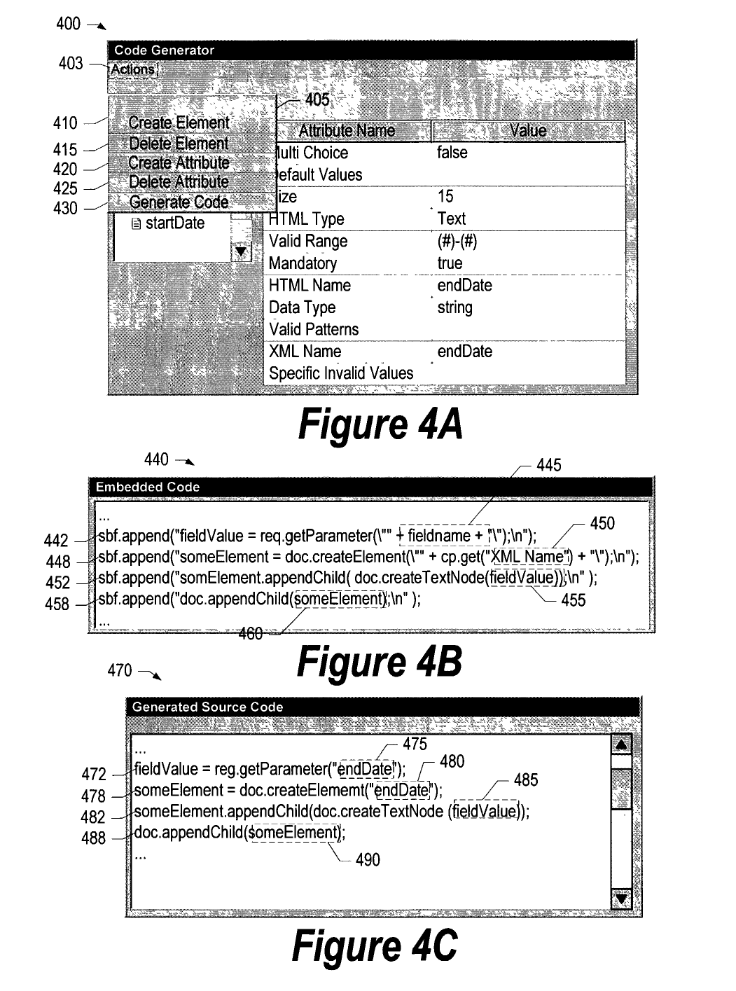

File configure 255 stores developer 260's changes in configured file 270, and sends configured file 270 to code generation 280. Code generation 280 receives configured file 270 and generates source code 290 (see FIGS. 4B, 4C, and corresponding text for further details regarding source code generation). Source code 290 may be input to a processing engine (i.e. Java Virtual Machine) to generate an XML document (see FIG. 1 and corresponding text for further details regarding document generation).

FIG. 3A is a developer interface window showing file information corresponding to a hierarchical file. A developer uses window 300 to add a root element name to the hierarchical file and to review information retrieved during the hierarchical file generation process. Window 300 includes area 315 which shows a list of elements that correspond to HTML tags in an HTML file (see FIG. 2 for further details regarding hierarchical file generation). Folder 305 corresponds to a root element that is a parent element to the other elements shown in other elements shown in area 315. When a developer selects folder 305, window 300 displays root element attribute names and values which are displayed in column 320 and column 325, respectively. Column 320 includes HTML file, root element name, and code template. Box 340 includes the name of the HTML file that processing extracted HTML tags to generate the hierarchical file. The developer enters a root element name in box 342 that is the name that processing uses for a root element in a generated XML document. The developer identifies a correct root element name by determining what name his computer systems expects in a generated XML document. The developer enters a code template name in box 344 which is used to name a generated source code file.

Window 300 also includes validation attribute names and corresponding validation values which are shown in column 330 and column 335, respectively. Validation attributes are attributes that are used to generate a validation routine. A Java Virtual Machine (JVM) uses validation routines to ensure data values received from an HTML file meet designated criteria. Validation attribute values are a names of Java classes that either 1) generate code that performs a particular validation or 2) the names of classes that performs the validation. For example, “String” and “Date” are validation attribute names that may be used to validate a data value.

Column 330 includes four validation attribute names which are range validator, mandatory validator, size validator, and pattern validator. The developer specifies a Java class for range validator in box 346 that is used to ensure a data value received from the HTML file meets criteria specified in a “valid range” general attribute value. The developer specifies a Java class for mandatory validator in box 348 that is used to ensure a data value received from the HTML file meets criteria specified in a “mandatory” general attribute value. The developer specifies a Java class for size validator in box 350 that is used to ensure a data value received from the HTML file meets criteria specified in a “size” general attribute value. The developer specifies a Java class for pattern validator in box 352 that is used to ensure a data value received from the HTML file meets criteria specified in a “valid pattern” general attribute value (see FIG. 3B for further details regarding general attributes).

FIG. 3B is a developer interface window showing attributes corresponding to a particular element. Window 360 shows a developer selecting element 362. Column 365 includes a list of general attribute names corresponding to element 362. Processing uses general attributes when generating source code. For example, a general attribute name may be “size” which represents the number of digits required for a valid customer account number and the general attribute name “size” may have a corresponding general attribute value of “10”.

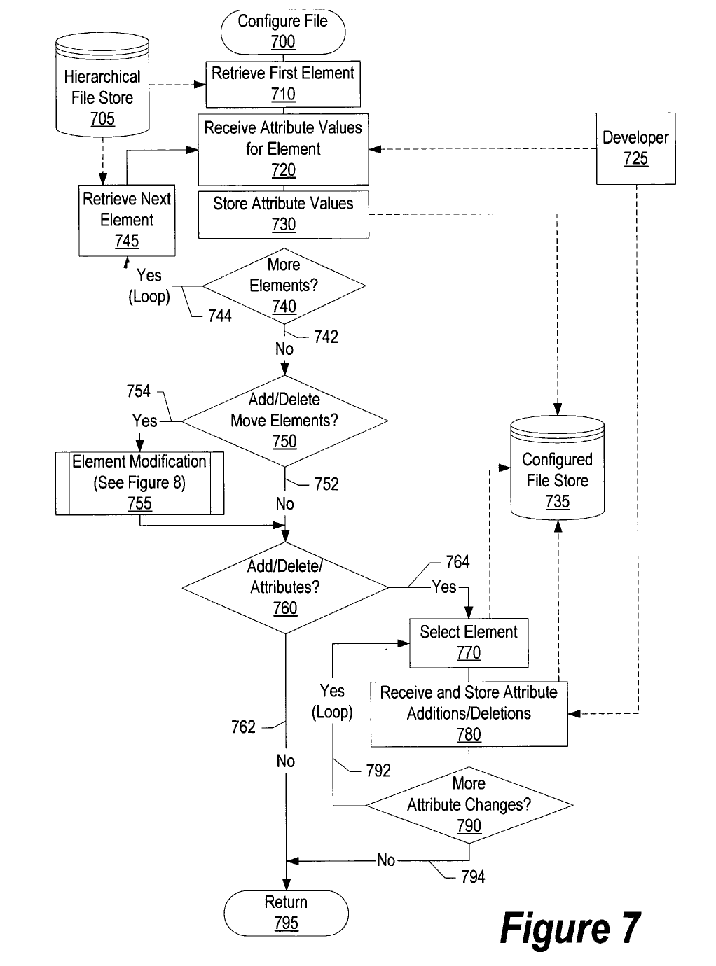

Column 365 includes eleven general attribute names and column 370 includes values corresponding to each general attribute value. The developer may add or delete attributes if he wishes (see FIG. 7 and corresponding text for further details regarding element modifications). The developer enters a multi-choice value in box 372 which is used to specify if more than one data value may be received from the particular element from an HTML file. A “true” value in this field instructs the tool to generate code that produces multiple elements for the corresponding HTML field. For example, if an HTML page provides a user with the choices of 1. User, 2. Group, and 3. Contact to send a notification, and the user selects “1” and “3”, then multi-choice is marked “true” and the element names will be “user” and “contact”. The developer enters a default value in box 374 in that processing uses if a data value received from the HTML file does not include a value. The developer enters a size number in box 376 which specifies an amount of characters for the corresponding element. An HTML type value is displayed in box 378 which tells the developer the type of the corresponding HTML field. The developer enters a valid range in box 380 which includes values that are used to validate data values submitted from an HTML file. The developer enters a “mandatory” value in box 382 which informs processing whether to validate a data value is received from a HTML file for the particular element. Processing displays an HTML name in box 384 that represents a field name in the HTML document corresponding to the element. The HTML name may be a read only attribute. The developer enters a data type in box 386 which is used to ensure that code is generated to validate the value type submitted to the server. The developer enter a valid pattern in box 388 which is used to ensure that the values submitted through the HTML page follows the specified pattern. The developer enters an XML name in box 390 that will correspond to the element name in an XML document when the document is generated. The developer enters specific invalid values in box 392 which are used to validate and ensure that the value received from an HTML file shall not be any of the specified values in the field.

FIG. 4A is a developer interface window showing menu items to create additional elements and attributes for a particular hierarchical file. Window 400 shows menu item 403 that a developer selects to modify an element or an attribute. When the developer selects menu item 403, processing displays window 405 which includes five developer selections which are “create element”, “delete element”, “create attribute”, and “generate code”.

The developer may select box 410 to add a new element to the hierarchical file. For example, the developer may wish to add a parent element to nest one or more existing elements under the new parent element. In this example, the developer selects box 410 to generate a parent element and then moves the existing elements under the parent element (see FIG. 8 and corresponding text for further details regarding element nesting). The developer may select box 415 to delete an existing element. For example, the hierarchical file may include an element that the developer does not wish to obtain corresponding data. In this example, the developer selects box 415 to delete the element (see FIG. 8 and corresponding text for further details regarding element deletion).

The developer may select box 420 to create a new attribute. For example, the developer may wish to add an attribute that identifies the time of day that a user enters data into the corresponding HTML page. In this example, the developer selects box 420 to add a new attribute. The developer may select box 425 to delete an existing attribute. For example, the developer may wish to delete an attribute named “mandatory”. In this example, the developer selects box 425 to delete the “mandatory” attribute. When the developer is satisfied with the elements, attributes, and attribute values, the developer selects box 430 to generate source code (see FIG. 4B and corresponding text for further details regarding source code).

FIG. 4B is a developer interface window showing an example of embedded code in a code generator for generating a source code snippet for an element. Window 440 includes four lines of embedded code that the code generator uses to generate source code for each element within a hierarchical file. Line 442 shows that the code generator retrieves an element's “fieldname” from the hierarchical file as shown in box 445, and generates a line of source code using the element's field name. For example, if an element's field name is “endDate”, the code generator generates a source code line:

fieldValue=req.getParameter(“endDate”)

Line 448 shows that the code generator retrieves an elements “XML Name” from the hierarchical file as shown in box 450, and generates a line of source code using the element's XML Name. Line 452 shows that the code generator generates a line of code to retrieve an element's field value, such as shown in box 455. Line 458 shows that the code generator generates a line of code to append the element to its parent element, such as shown in box 460. A developer may add more or less lines of embedded code for generating source code for based upon the developer's source code snippet requirements. A developer may also instruct a code generator to retrieve a source code template file from a storage area and use the source code template file to generate source code snippets for each element.

FIG. 4C is a developer interface window showing generated source code using embedded code in a code generator (see FIG. 4B and corresponding text for further details regarding embedded source code). The code generator uses elements in a configured file and generates source code snippets for each element in the configured file. The code generator retrieves attribute information for each element, and generates source code based upon general attribute values for the corresponding element.

Using line 442 in FIG. 4B, the code generator retrieved a field name “endDate” and generated line 472 which includes “endDate” as a field name, such as shown in box 475. Using line 448 in FIG. 4B, the code generator retrieved an XML name “endDate” and generated line 478 which includes “endDate” as an XML name, such as shown in box 480.

Using line 452 in FIG. 4B, the code generator generated line 482 which retrieves a field value of the element, such as shown in box 485. Using line 458 in FIG. 4B, the code generator generated line 488 which appends the element to its parent element, such as shown in box 490.

FIG. 5 is a high-level flowchart showing steps taken in retrieving an HTML file and generating source code that creates an XML document. Processing commences at 500, whereupon an HTML file is retrieved from HTML store 510 (step 505). For example, the HTML file may correspond to a screen that requests personal information from a user, such as a registration screen. HTML store 510 may be stored on a non-volatile storage area, such as a computer hard drive.

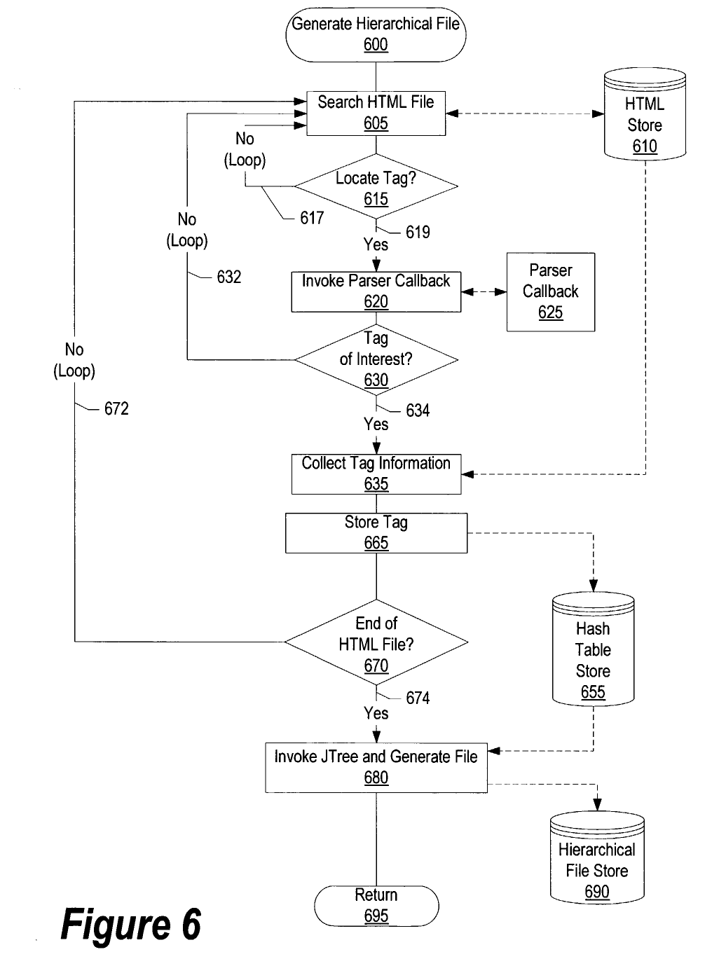

Processing identifies HTML tags in the HTML file and creates a hierarchical file that includes an element that corresponds to each HTML tag (pre-defined process block 520, see FIG. 6 and corresponding text for further details). The hierarchical file is stored in hierarchical file store 525. Hierarchical file store 525 may be stored on a non-volatile storage area, such as a computer hard drive. Using the example described above, processing may identify HTML tags with corresponding names of “name” and “address”. In this example, the hierarchical file will include elements “name” and “address”. A determination is made as to whether the developer wishes to configure the hierarchical file (decision 530). For example, the developer may wish to enter attribute value information corresponding to each element (see FIGS. 3A, 3B, and corresponding text for further details regarding attributes).

If the developer wishes to configure the hierarchical file, decision 530 branches to “Yes” branch 532 whereupon processing receives developer input and stores a configured file in configured file store 540 (pre-defined process block 535, see FIG. 7 for further details). Configured file store 540 may be stored on a non-volatile storage area, such as a computer hard drive. On the other hand, if the developer does not wish to amend the hierarchical file, decision 530 branches to “No” branch 534 bypassing file amending steps.

A determination is made as to whether the developer wishes to generate source code using the amended hierarchical file (decision 545). If the developer does not wish to generate source code at this time, decision 545 branches to “No” branch 549 bypassing code generation steps. On the other hand, if the developer wishes to generate source code, decision 545 branches to “Yes” branch 547 whereupon processing retrieves attribute information corresponding to a first element from configured file store 540 (step 550). Processing uses the first element's attribute information, such as its hierarchy structure (i.e. parent, child) and name, to generate source code and store the source code in code store 560 (step 555). Processing generates source code corresponding to standard code writing techniques for retrieving information from an HTML based application (see FIGS. 4B, 4C, and corresponding text for further details regarding source code generation). Code store 560 may be stored on a non-volatile storage area, such as a computer hard drive.

A determination is made as to whether there are more elements to generate corresponding source code in configured file store 540 (decision 565). If there are more elements to generate corresponding source code, decision 565 branches to “Yes” branch 569 which loops back to retrieve (step 570) and process the next element. This looping continues until there are no more elements to generate corresponding source code, at which point decision 565 branches to “No” branch 567. Processing retrieves the source code from code store 560 and provides the source code to developer 590 at step 580. Processing ends at 595.

FIG. 6 is a flowchart showing steps taken in generating a hierarchical file. File generation processing commences at 600, whereupon processing searches an HTML file located in HTML store 610 for one or more HTML tags (step 605). HTML store 610 may be stored on a non-volatile storage area, such as a computer hard drive. A determination is made as to whether processing locates an HTML tag (decision 615). If processing does not locate an HTML tag, decision 615 branches to “No” branch 617 which loops back to continue searching for an HTML tag. This looping continues until processing locates an HTML tag, at which point decision 615 branches to “Yes” branch 619 whereupon processing invokes parser callback 625 at step 620.

Parser callback 625 analyzes the detected HTML tag to determine whether the tag should be included in the hierarchical file. For example, parser callback 620 may be configured to select tags of interest such as “hidden”, “input”, “textarea”, “select”, “checkbox”, and “radio”. A determination is made as to whether the detected tag should be included in the hierarchical file (decision 630). If the tag should not be included in the hierarchical file, decision 630 branches to “No” branch 632 which loops back to continue searching for HTML tags. This looping continues until parser callback 625 locates a tag of interest, at which point decision 630 branches to “Yes” branch 634. Processing collects information from HTML store 610 corresponding to the relevant tag at step 635 and stores the information in hash table store 655. Using the example described above, processing may collect size and name information corresponding to a “select” tag and store the information in hash table store 655. Hash table store 655 may be stored on a non-volatile storage area, such as a computer hard drive.

A determination is made as to whether processing is finished searching the HTML file (decision 670). If processing is finished searching the HTML file, decision 670 branches to “No” branch 672 which loops back to search for more HTML tags. This looping continues until processing is finished searching the HTML file, at which point decision 670 branches to “Yes” branch 674.

Processing invokes a Java-based Jtree command at step 680. The Jtree command retrieves each HTML tag and its corresponding information located in hash table store 655 and generates a hierarchical file. The hierarchical file is stored in hierarchical file store 690 (step 680). Hierarchical file store 690 may be stored on a non-volatile storage area, such as a computer hard drive. Processing returns at 695.

FIG. 7 is a flowchart showing steps taken in amending a hierarchical file. Processing commences at 700, whereupon processing retrieves a first element from the hierarchical file located in hierarchical file store 705 (step 710). The hierarchical file includes one or elements that correspond to one or more HTML tags in an HTML file. Hierarchical file store 705 may be stored on a non-volatile storage area, such as a computer hard drive. Processing receives one or more attribute values from developer 725 corresponding to the first element at step 720, and stores the attribute values in configured file store 735 (step 730). For example, developer 725 may specify a “valid range” for the first element from “0-255”. Configured file store 735 may be stored on a non-volatile storage area, such as a computer hard drive.

A determination is made as to whether there are more elements to assign attributes values in hierarchical file store 705 (decision 740). If there are more elements to assign attribute values, decision 740 branches to “Yes” branch 744 which loops back to retrieve (step 745) and process the next element. This looping continues until there are no more elements to process, at which point decision 740 branches to “No” branch 742.

A determination is made as to whether the developer wishes to add, delete, or move an element (decision 750). For example, the developer may wish to nest (i.e. move) one or more elements under an existing element. If the developer wishes to add, delete, or move an element, decision 750 branches to “Yes” branch 754 whereupon the developer modifies one or more of the elements (pre-defined process block 755, see FIG. 8 and corresponding text for further details). On the other hand, if the developer does not wish to add, delete, or move an element, decision 750 branches to “No” branch 752, bypassing element modification steps.

A determination is made as to whether the developer wishes to add or delete an attribute for a particular element (decision 760). For example, the developer may wish to remove an attribute name “multi-choice” from an element “accoutnumber”. If the developer does not wish to add or delete an attribute, decision 760 branches to “No” branch 762 bypassing attribute changing steps. On the other hand, if the developer wishes to add or delete an attribute, decision 760 branches to “Yes” branch 764 whereupon processing selects the corresponding element at step 770 based upon developer 725's input. Using the example described above, processing selects “accountnumber” located in amend file store 735. Processing receives attribute changing information from developer 725 and stores the changes in amend file store 735 (step 780). Using the example described above, developer 725 instructs processing to delete the attribute “multi-choice” from the “accountnumber” element.

A determination is made as to whether developer 725 wishes to add or delete more attributes (decision 790). If developer 725 wishes to add or delete more attributes, decision 790 branches to “Yes” branch 792 which loops back to process the next attribute request. This looping continues until developer 725 does not wish to add or delete more attributes, at which point decision 790 branches to “No” branch 794. Processing returns at 795.

FIG. 8 is a flowchart showing steps taken in modifying elements corresponding to a hierarchical file. Element modification processing commences at 800, whereupon a determination is made as to whether a developer wishes to add an element (decision 810). For example, the developer may wish to add a parent element “dates” and nest existing elements under the parent element, such as “startdate” and “enddate”. If the developer wishes to add an element to the hierarchical file, decision 810 branches to “Yes” branch 812 whereupon processing receives information from the developer and creates a new element and stores the new element in configured file store 825 (step 820). Using the example described above, processing creates an element “dates” and stores it in configured file store 825. Configured file store 825 may be stored on a non-volatile storage area, such as a computer hard drive. Processing receives attribute information corresponding to the new element and stores the attribute information in configured file store 825 (see FIGS. 3A, 3B, and corresponding text for further details regarding attribute names and attribute values). If the developer does not wish to add an element to the hierarchical file, decision 810 branches to “No” branch 818 bypassing element creation steps.

A determination is made as to whether the developer wishes to delete an existing element (decision 840). For example, the developer may wish to delete an element “usertype” from the hierarchical file. If the developer wishes to delete and element, decision 840 branches to “Yes” branch 842 whereupon processing selects and deletes the element from configured file store 825 (step 850). Using the example described above, processing selects and deletes the element “usertype” from configured file store 825. On the other hand, if the developer does not wish to delete an existing element, decision 840 branches to “No” branch 848 bypassing element deletion steps.

A determination is made as to whether the developer wishes to move an element (decision 860). Using the example described above, the developer may have created a “dates” element and wish to move, or nest, other elements under the “dates” element. If the developer wishes to move an element, decision 860 branches to “Yes” branch 862 whereupon processing selects the element that the developer wishes to move (step 870). Using the example described above, processing may select the element “startdate”. Processing selects the new location of the element at step 880. Using the example described above, processing selects the element “dates”. Processing repositions the moving element from its original location to its new location at step 890. On the other hand, if the developer does not wish to move an element, decision 860 branches to “No” branch 868.

A determination is made as to whether the developer wishes to make more element changes (decision 895). If the developer wishes to make more element changes, decision 895 branches to “Yes” branch 898 which loops back to process more developer requests. This looping continues until the developer does not have more element changes, at which point decision 895 branches to “No” branch 896. Processing returns at 899.

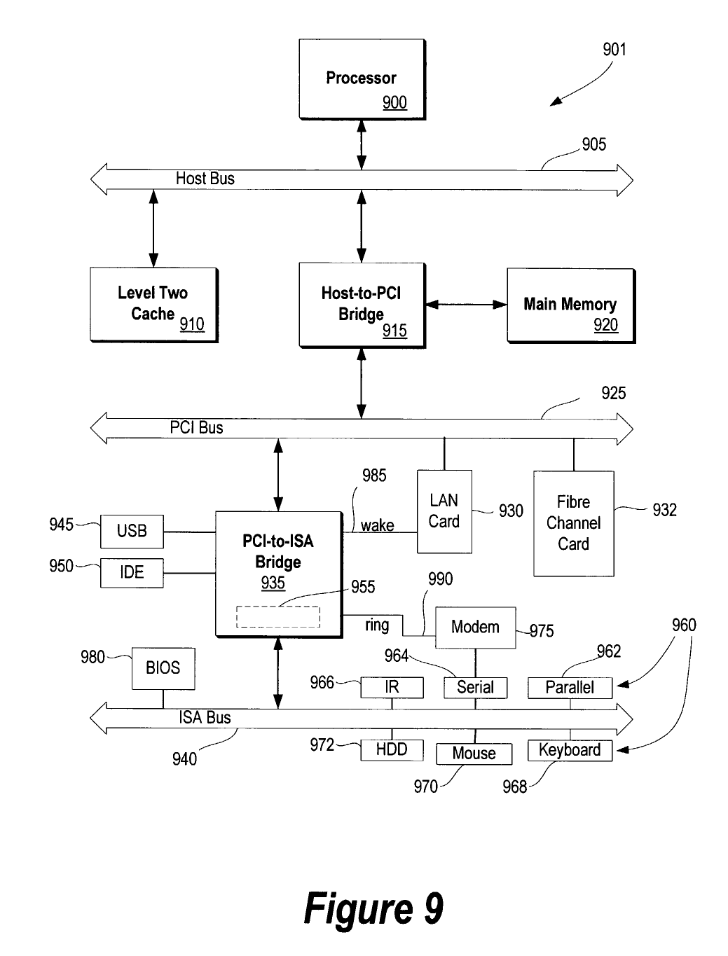

FIG. 9 illustrates information handling system 901 which is a simplified example of a computer system capable of performing the invention described herein. Computer system 901 includes processor 900 which is coupled to host bus 905. A level two (L2) cache memory 910 is also coupled to the host bus 905. Host-to-PCI bridge 915 is coupled to main memory 920, includes cache memory and main memory control functions, and provides bus control to handle transfers among PCI bus 925, processor 900, L2 cache 910, main memory 920, and host bus 905. PCI bus 925 provides an interface for a variety of devices including, for example, LAN card 930. PCI-to-ISA bridge 935 provides bus control to handle transfers between PCI bus 925 and ISA bus 940, universal serial bus (USB) functionality 945, IDE device functionality 950, power management functionality 955, and can include other functional elements not shown, such as a real-time clock (RTC), DMA control, interrupt support, and system management bus support. Peripheral devices and input/output (I/O) devices can be attached to various interfaces 960 (e.g., parallel interface 962, serial interface 964, infrared (IR) interface 966, keyboard interface 968, mouse interface 970, and fixed disk (HDD) 972) coupled to ISA bus 940. Alternatively, many I/O devices can be accommodated by a super I/O controller (not shown) attached to ISA bus 940.

BIOS 980 is coupled to ISA bus 940, and incorporates the necessary processor executable code for a variety of low-level system functions and system boot functions. BIOS 980 can be stored in any computer readable medium, including magnetic storage media, optical storage media, flash memory, random access memory, read only memory, and communications media conveying signals encoding the instructions (e.g., signals from a network). In order to attach computer system 901 to another computer system to copy files over a network, LAN card 930 is coupled to PCI bus 925 and to PCI-to-ISA bridge 935. Similarly, to connect computer system 901 to an ISP to connect to the Internet using a telephone line connection, modem 975 is connected to serial port 964 and PCI-to-ISA Bridge 935.

While the computer system described in FIG. 9 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of creating source code, said method comprising:
receiving a hierarchical file wherein the hierarchical file includes one or more element names, wherein each of the element names corresponds to an element;
generating the source code, wherein the source code includes one or more of the element names; and
associating one or more attribute values with one or more of the elements, wherein the attribute values are adapted to be retrieved during execution of the source code.

2. The method as described in claim 1 wherein the hierarchical file is generated using a JTree.

3. The method as described in claim 1 wherein the elements are a plurality of elements, the method further comprising:
selecting a first element from the plurality of elements;
identifying a second element from the plurality of elements; and
linking the first element with the second element.

4. The method as described in claim 3 wherein the linking includes nesting the first element under the second element.

5. The method as described in claim 1 wherein each attribute value has an associated attribute name, and wherein at least one of the attribute names is selected from the group consisting of a multi-choice, a default value, a size, an HTML type, a valid range, a mandatory, an HTML name, a data type, a valid pattern, an XML name, a specific invalid value, a range validator, a mandatory validator, a type validator, a size validator, and a pattern validator.

6. The method as described in claim 1 further comprising:
executing the source code, the executing including:
selecting one of the attribute values;
receiving a data value corresponding to one of the elements wherein the data value is received from an HTML page;
analyzing the data value using the selected attribute value; and
generating an error message based upon the analysis.

7. The method as described in claim 1 further comprising:
adding a new element to the hierarchical file; and
performing the generating and associating using the new element.

8. The method as described in claim 1 wherein the generated source code is used to generate an XML document.

9. An information handling system comprising:
one or more processors;
a memory accessible by the processors;
one or more nonvolatile storage devices accessible by the processors; and
a source code generation tool to generate source code, the source code generation tool including:
means for receiving a hierarchical file wherein the hierarchical file includes one or more element names, wherein each of the element names corresponds to an element;
means for generating the source code, wherein the source code includes one or more of the element names; and
means for associating one or more attribute values with one or more of the elements, wherein the attribute values are adapted to be retrieved during execution of the source code.

10. The information handling system as described in claim 9 wherein the hierarchical file is generated using a JTree.

11. The information handling system as described in claim 9 wherein the elements are a plurality of elements, the information handling system further comprising:
means for selecting a first element from the plurality of elements;
means for identifying a second element from the plurality of elements; and
means for linking the first element with the second element.

12. The information handling system as described in claim 11 wherein the linking includes nesting the first element under the second element.

13. The information handling system as described in claim 9 wherein each attribute value has an associated attribute name, and wherein at least one of the attribute names is selected from the group consisting of a multi-choice, a default value, a size, an HTML type, a valid range, a mandatory, an HTML name, a data type, a valid pattern, an XML name, a specific invalid value, a range validator, a mandatory validator, a type validator, a size validator, and a pattern validator.

14. The information handling system as described in claim 9 further comprising:
means for executing the source code, the executing including:
means for selecting one of the attribute values;
means for receiving a data value corresponding to one of the elements wherein the data value is received from an HTML page;
means for analyzing the data value using the selected attribute value; and
means for generating an error message based upon the analysis.

15. The information handling system as described in claim 9 further comprising:
means for adding a new element to the hierarchical file; and
means for performing the generating and associating using the new element.

16. The information handling system as described in claim 9 wherein the generated source code is used to generate an XML document.

17. A computer program product stored on a computer operable media for generating source code, said computer program product comprising:
means for receiving a hierarchical file wherein the hierarchical file includes one or more element names, wherein each of the element names corresponds to an element;
means for generating the source code, wherein the source code includes one or more of the element names; and
means for associating one or more attribute values with one or more of the elements, wherein the attribute values are adapted to be retrieved during execution of the source code.

18. The computer program product as described in claim 17 wherein the hierarchical file is generated using a JTree.

19. The computer program product as described in claim 17 wherein the elements are a plurality of elements, the computer program product further comprising:
means for selecting a first element from the plurality of elements;
means for identifying a second element from the plurality of elements; and
means for linking the first element with the second element.

20. The computer program product as described in claim 19 wherein the linking includes nesting the first element under the second element.

21. The computer program product as described in claim 17 wherein each attribute value has an associated attribute name, and wherein at least one of the attribute names is selected from the group consisting of a multi-choice, a default value, a size, an HTML type, a valid range, a mandatory, an HTML name, a data type, a valid pattern, an XML name, a specific invalid value, a range validator, a mandatory validator, a type validator, a size validator, and a pattern validator.

22. The computer program product as described in claim 17 further comprising:
means for executing the source code, the executing including:
means for selecting one of the attribute values;
means for receiving a data value corresponding to one of the elements wherein the data value is received from an HTML page;
means for analyzing the data value using the selected attribute value; and
means for generating an error message based upon the analysis.

23. The computer program product as described in claim 17 further comprising:
means for adding a new element to the hierarchical file; and
means for performing the generating and associating using the new element.

24. The computer program product as described in claim 17 wherein the generated source code is used to generate an XML document.
